(19) United States
(12) Patent Application Publication
(10) Pub. No.: US 2021/0034686 A1
(43) Pub. Date: Feb. 4, 2021

(54) SYSTEMS AND METHODS FOR IMPROVING USER EXPERIENCE FOR AN ON-LINE PLATFORM

(71) Applicant: BEIJING DIDI INFINITY TECHNOLOGY AND DEVELOPMENT CO., LTD, Beijing (CN)

(72) Inventors: Juan HU, Beijing (CN); Huan CHEN, Beijing (CN); Qi SONG, Beijing (CN)

(73) Assignee: BEIJING DIDI INFINITY TECHNOLOGY AND DEVELOPMENT CO., LTD., Beijing (CN)

(21) Appl. No.: 17/072,249

(22) Filed: Oct. 16, 2020

Related U.S. Application Data
(63) Continuation of application No. PCT/CN2018/083476, filed on Apr. 18, 2018.

(51) Int. Cl. G06F 16/9535; G06F 16/9537; G06F 40/274

(52) U.S. Cl. CPC G06F 16/9535; G06F 40/274; G06F 16/9537

(57) ABSTRACT

A method for improving user experience for an on-line platform may include obtaining a user input of a user of the on-line platform. The method may also include obtaining a plurality of candidate terms of interest (TOIs) that are selected by the user based on historical inputs relating to the user input. Each of the plurality of candidate TOIs may belong to a candidate category. The method may also include determining a target category for the user input based on the candidate categories and the plurality of candidate TOIs. The method may also include determining one or more target TOIs based on the target category and the plurality of candidate TOIs. The method may also include transmitting the one or more target TOIs to a terminal associated with the user.

### CROSS-REFERENCE TO RELATED APPLICATIONS

This application is a continuation of International Patent Application No. PCT/CN2018/083476, filed on Apr. 18, 2018, the contents of which are hereby incorporated by reference.

### TECHNICAL FIELD

The present disclosure generally relates to an on-line service platform, and in particular, relates to systems and methods for improving user experience for an on-line service platform.

### BACKGROUND

With the development of Internet technology, online to offline services are starting to play a significant role in people's daily lives. In most cases, one or more search functions are built into such online to offline services. When a user inputs a query to initiate a search for a term of interest (TOI), an on-line service platform may provide a plurality of TOIs relating to the query to the user for as both reminders and assistance for faster input. It may improve user experience to provide accurate TOIs to the user. Thus, it is desirable to provide systems and methods to provide accurate TOIs to improve user experience for an on-line service platform.

### SUMMARY

According to a first aspect of the present disclosure, a system for improving user experience for an on-line platform may include one or more storage media and one or more processors configured to communicate with the one or more storage media. The one or more storage media may include a set of instructions. When the one or more processors executing the set of instructions, the one or more processors may be directed to perform one or more of the following operations. The one or more processors may obtain a user input of a user of the on-line platform. The one or more processors may obtain a plurality of candidate terms of interest (TOIs) that are selected by the user based on historical inputs relating to the user input. Each of the plurality of candidate TOIs may belong to a candidate category. The one or more processors may determine a target category for the user input based on the candidate categories and the plurality of candidate TOIs. The one or more processors may determine one or more target TOIs based on the target category and the plurality of candidate TOIs. The one or more processors may transmit the one or more target TOIs to a terminal associated with the user.

In some embodiments, the user input may include a word, an incomplete word, or an abbreviation.

In some embodiments, to determine the target category for the user input based on the candidate categories and the plurality of candidate TOIs, the one or more processors may determine, for at least one of the candidate categories, a category probability that the user input belongs to the at least one of the candidate categories based on the plurality of candidate TOIs. The one or more processors may determine one of the candidate categories as the target category based on the at least one category probability.

In some embodiments, to determine, for at least one of the candidate categories, the category probability that the user input belongs to the at least one of the candidate categories based on the plurality of candidate TOIs, the one or more processors may obtain, for each of the plurality of candidate TOIs, a number of times that the user selects the candidate TOI. The one or more processors may determine a first number of times that the user selects the plurality of candidate TOIs. The one or more processors may determine a second number of times that the user selects the candidate TOIs that belong to the at least one of the candidate categories. The one or more processors may determine the category probability based on the first number of times and the second number of times.

In some embodiments, to determine, for at least one of the candidate categories, the category probability that the user input belongs to the at least one of the candidate categories based on the plurality of candidate TOIs, the one or more processors may determine the category probability that the user input belongs to the at least one of the candidate categories based on the following equation:

P(Cⱼ|Q)=ΣᵢP(poiᵢ ∈Cⱼ|Q)=Σᵢ P(poiᵢ ∈Cⱼ)*P(poiᵢ|Q),

where Q refers to the user input; Cⱼ refers to the at least one of the candidate categories; poi, refers to one of the plurality of candidate TOIs, i is a positive integer; P(Cⱼ|Q) refers to the category probability that the user input belongs to the at least one of the candidate categories; P(poiᵢ ∈Cⱼ|Q) refers to a probability of selecting poi, that belongs to Cⱼ based on Q; P(poiᵢ ∈Cⱼ) refers to whether poiᵢ belongs to Cⱼ, and P(poiᵢ ∈Cⱼ) is equal to 1 or 0; and P(poiᵢ|Q) refers to a probability of selecting poi, based on Q, which is determined by dividing a number of times that the user selects poiᵢ by a total number of times that the user selects the plurality of candidate TOIs.

In some embodiments, the candidate categories may include a general request category, a chain request category, and a precise request category.

In some embodiments, to determine the target category for the user input based on the candidate categories and the plurality of candidate TOIs, the one or more processors may determine a probability of the general request category that the user input belongs to the general request category based on the plurality of candidate TOIs. The one or more processors may determine the general request category as the target category when the probability of the general request category is higher than a first threshold, or determine the precise request category or the chain request category as the target category when the probability of the general request category is lower than a second threshold.

In some embodiments, to determine the one or more target TOIs based on the target category and the plurality of candidate TOIs, the one or more processors may obtain a number of times that each candidate POI that belongs to the target category is selected by the user. The one or more processors may determine the one or more target TOIs in the candidate TOIs that belong to the target category based on the number of times that each candidate POI that belongs to the target category is selected by the user. The number of times that each candidate POI that belongs to the target category is selected by the user may be greater than a third threshold.

In some embodiments, to determine the one or more target TOIs based on the target category and the plurality of candidate TOIs, the one or more processors may obtain a location of the user. For each of the candidate TOIs that belong to the target category, the one or more processors may determine a distance between the location of the user and the candidate TOI. The one or more processors may determine the one or more target TOIs in the candidate TOIs that belong to the target category based on the distances between the location of the user and each of the candidate TOIs that belong to the target category. The one or more target TOIs may be within a predetermined distance away from the location of the user.

In some embodiments, the TOI may be a point of interest (P01).

According to another aspect of the present disclosure, a method for improving user experience for an on-line platform may include one or more of the following operations. One or more processors may obtain a user input of a user of the on-line platform. The one or more processors may obtain a plurality of candidate terms of interest (TOIs) that are selected by the user based on historical inputs relating to the user input. Each of the plurality of candidate TOIs may belong to a candidate category. The one or more processors may determine a target category for the user input based on the candidate categories and the plurality of candidate TOIs. The one or more processors may determine one or more target TOIs based on the target category and the plurality of candidate TOIs. The one or more processors may transmit the one or more target TOIs to a terminal associated with the user.

According to yet another aspect of the present disclosure, a non-transitory computer readable medium may comprise at least one set of instructions. The at least one set of instructions may be executed by one or more processors of a computer server. The one or more processors may obtain a user input of a user of the on-line platform. The one or more processors may obtain a plurality of candidate terms of interest (TOIs) that are selected by the user based on historical inputs relating to the user input. Each of the plurality of candidate TOIs may belong to a candidate category. The one or more processors may determine a target category for the user input based on the candidate categories and the plurality of candidate TOIs. The one or more processors may determine one or more target TOIs based on the target category and the plurality of candidate TOIs. The one or more processors may transmit the one or more target TOIs to a terminal associated with the user.

According to yet another aspect of the present disclosure, a system for improving user experience for an on-line platform may comprise an input obtaining module configured to obtain a user input of a user of the on-line platform. The system for improving user experience for an on-line platform may also comprise a historical information obtaining module configured to obtain a plurality of candidate terms of interest (TOIs) that are selected by the user based on historical inputs relating to the user input. Each of the plurality of candidate TOIs may belong to a candidate category. The system for improving user experience for an on-line platform may also comprise a category determination module configured to determine a target category for the user input based on the candidate categories and the plurality of candidate TOIs. The system for improving user experience for an on-line platform may also comprise a TOI determination module configured to determine one or more target TOIs based on the target category and the plurality of candidate TOIs. The system for improving user experience for an on-line platform may also comprise a transmission module configured to transmit the one or more target TOIs to a terminal associated with the user.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-line service system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a flowchart illustrating an exemplary process for transmitting target TOIs to a terminal associated with a user according to some embodiments of the present disclosure;

FIG. 6 is a flowchart illustrating an exemplary process for determining a target category for a user input according to some embodiments of the present disclosure;

FIG. 7 is a flowchart illustrating an exemplary process for determining one or more target TOIs according to some embodiments of the present disclosure;

FIG. 8 is a flowchart illustrating an exemplary process for determining one or more target TOIs according to some embodiments of the present disclosure; and

FIGS. 9-12 are schematic diagrams illustrating exemplary user interfaces displaying a user input and target TOIs in a user terminal according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, the systems and methods in the present disclosure may be applied to any application scenario in which a user requires to search a TOI. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system or method of the present disclosure may be applied to taxi hailing, chauffeur services, delivery service, carpool, bus service, take-out service, driver hiring, vehicle hiring, bicycle sharing service, train service, subway service, shuttle services, location service, or the like. As another example, the system or method of the present disclosure may be applied to shopping service, learning service, fitness service, financial service, social service, or the like. The application scenarios of the system or method of the present disclosure may include a web page, a plug-in of a browser, a client terminal, a custom system, an internal analysis system, an artificial intelligence robot, or the like, or any combination thereof.

In some embodiments, when a user inputs a query to initiate a search for a TOI, an on-line service platform may provide a plurality of TOIs relating to the query to the user for quick input. To this end, after receiving the user input from a user terminal (e.g., the user's smartphone, the user's computer), the on-line service platform may determine which category the user input belongs to (e.g., the user's intention). The on-line service platform may determine one or more TOIs belonging to the category of the user input and transmit the one or more TOIs to the user terminal. The user terminal may display the one or more TOIs. The user may select one of the displayed one or more TOIs for quick input.

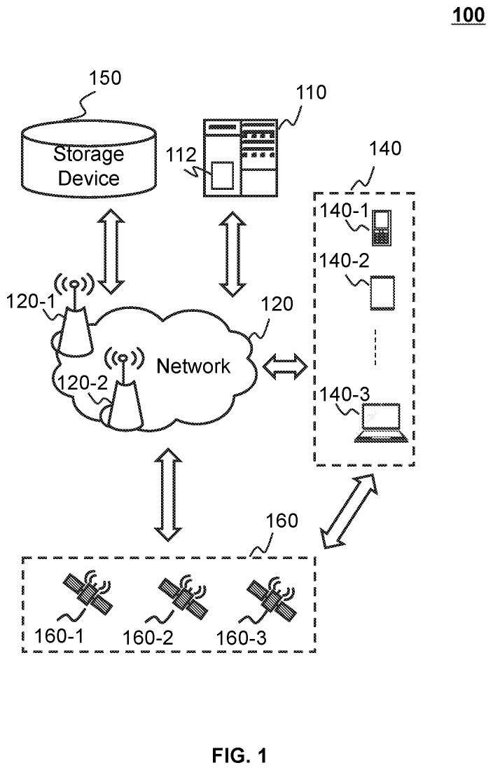

FIG. 1 is a schematic diagram of an exemplary on-line service system according to some embodiments. The on-line service system 100 may include a server 110, a network 120, a user terminal 140, a storage device 150, and a positioning system 160.

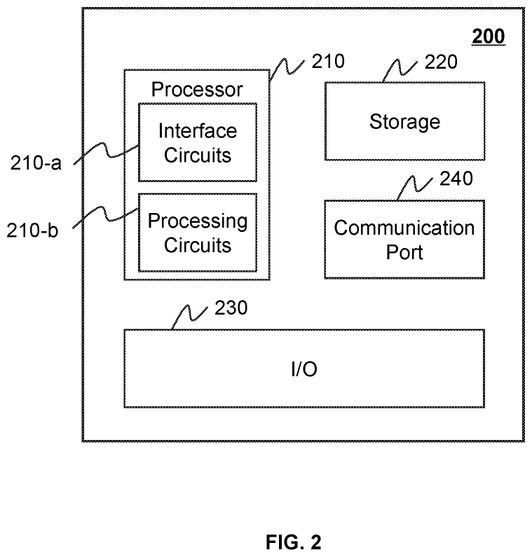

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the user terminal 140, and/or the storage device 150 via the network 120. As another example, the server 110 may be directly connected to the user terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may determine one or more target TOIs based on a user input. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the on-line service system 100 (e.g., the server 110, the user terminal 140, the storage device 150, and the positioning system 160) may send information and/or data to other component(s) in the on-line service system 100 via the network 120. For example, the processing engine 112 may obtain a plurality of candidate TOIs that are selected by the user based on historical inputs relating to a user input from the storage device 150 and/or the user terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-line service system 100 may be connected to the network 120 to exchange data and/or information.

In some embodiments, the user terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the user terminal 140 may be a device with positioning technology for locating the position of the user terminal 140. In some embodiments, the user terminal 140 may send positioning information to the server 110.

The storage device 150 may store data and/or instructions. In some embodiments, the storage device 150 may store data obtained from the user terminal 140 and/or the processing engine 112. For example, the storage device 150 may store a plurality of candidate TOIs obtained from the user terminal 140. As another example, the storage device 150 may store candidate categories for each of the plurality of candidate TOIs determined by the processing engine 112. In some embodiments, the storage device 150 may store data and/or instructions that the server 110 may execute or use to perform exemplary methods described in the present disclosure. For example, the storage device 150 may store instructions that the processing engine 112 may execute or user to determine target TOIs. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the on-line service system 100 (e.g., the server 110, the user terminal 140, etc.). One or more components in the on-line service system 100 may access the data or instructions stored in the storage device 150 via the network 120. In some embodiments, the storage device 150 may be directly connected to or communicate with one or more components in the on-line service system 100 (e.g., the server 110, the user terminal 140, etc.). In some embodiments, the storage device 150 may be part of the server 110.

The positioning system 160 may determine information associated with an object, for example, the user terminal 140. For example, the positioning system 160 may determine a location of the user terminal 140 in real time. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, or the user terminal 140 via wireless connections.

FIG. 2 is a schematic diagram illustrating exemplary hardware and/or software components of a computing device on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may process a plurality of candidate TOIs obtained from the user terminal 140, the storage device 150, and/or any other component of the on-line service system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the user terminal 140, the storage device 150, and/or any other component of the on-line service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for determining target TOIs.

The I/O 230 may input and/or output signals, data, information, etc. In some embodiments, the I/O 230 may enable a user interaction with the processing engine 112. For example, a user of the on-line service system 100 may input a predetermined parameter through the I/O 230. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the user terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

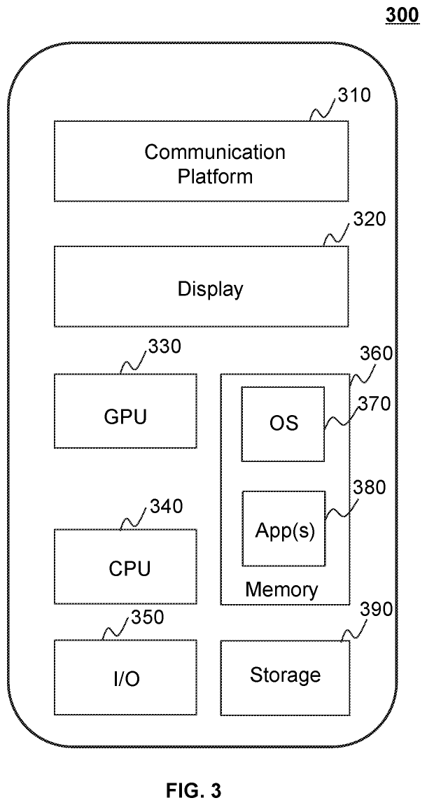

FIG. 3 is a schematic diagram illustrating exemplary hardware and/or software components of a mobile device on which the user terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the on-line service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the on-line service system 100 performs, the element may perform through electrical signals and/or electromagnetic signals. For example, when the processing engine 112 processes a task, such as making a determination, or identifying information, the processing engine 112 may operate logic circuits in its processor to process such task. When the processing engine 112 receives data (e.g., a user input) from the user terminal 140, a processor of the processing engine 112 may receive electrical signals including the data. The processor of the processing engine 112 may receive the electrical signals through an input port. If the user terminal 140 communicates with the processing engine 112 via a wired network, the input port may be physically connected to a cable. If the user terminal 140 communicates with the processing engine 112 via a wireless network, the input port of the processing engine 112 may be one or more antennas, which may convert the electrical signals to electromagnetic signals. Within an electronic device, such as the user terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

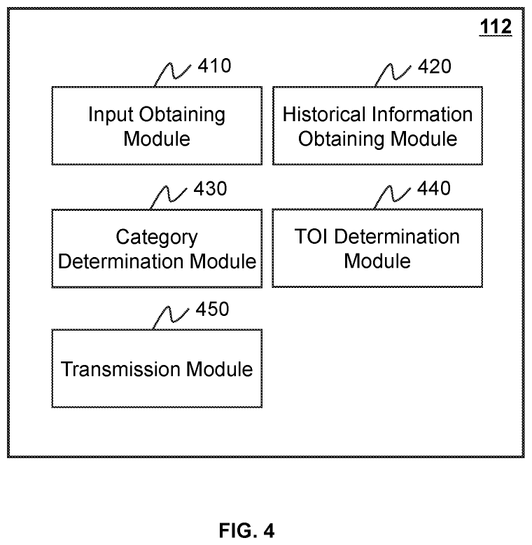

FIG. 4 is a schematic block diagram illustrating an exemplary processing engine according to some embodiments of the present disclosure. The processing engine 112 may include an input obtaining module 410, a historical information obtaining module 420, a category determination module 430, a TOI determination module 440, and a transmission module 450.

The input obtaining module 410 may be configured to obtain a user input of a user of the on-line service system 100. In some embodiments, the input obtaining module 410 may obtain the user input from the user terminal 140 via the network 120.

In some embodiments, the user terminal 140 may establish a communication (e.g., wireless communication) with the server 110, through an application (e.g., the application 380 in FIG. 3) installed in the user terminal 140 or a webpage in a browser via the network 120. The application may be associated with the on-line service system 100. For example, the application may be a taxi-hailing application associated with the on-line service system 100.

In some embodiments, after the user inputs a user input (e.g., a query), the user may send the user input to the processing engine 112 (e.g., the input obtaining module 410) by, for example, pressing a button in an interface of the application. In some embodiments, the application installed in the user terminal 140 may direct the user terminal 140 to monitor, continuously or periodically, input from the user and automatically transmit the input to the processing engine 112 via the network 120.

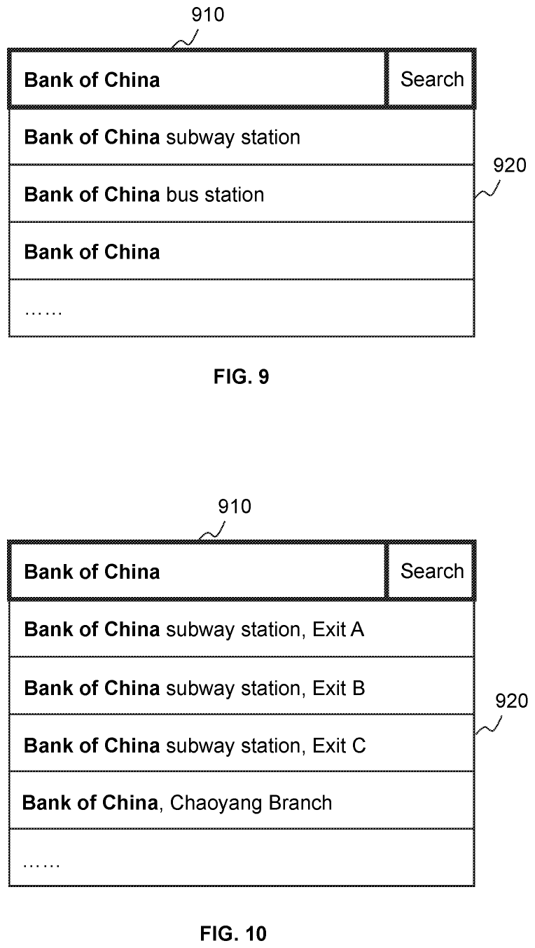

In some embodiments, the user input may be in the form of text, audio, video, or graph. The user input may include one or more words (e.g., as shown in a search box 910 in FIGS. 9-11), an incomplete word, an abbreviation (e.g., as shown in the search box 910 in FIG. 12), or the like, or any combination thereof. For example, the user input may be “bank,” “ba,” or “KFC”.

The historical information obtaining module 420 may be configured to obtain a plurality of candidate terms of interest (TOIs) that are selected by the user based on historical inputs relating to the user input.

In some embodiments, the TOI may be a point of interest (POI) (e.g., name of a location or a business name). For example, the POI may relate to a destination of a trip in a taxi hailing service. In some embodiments of the present invention, POIs may serve as examples of TOIs, as shown in the examples herein provided. It should be noted, however, that in some embodiments, the systems and methods of the present invention may apply to TOIs that are not POIs.

In some embodiments, the user may input a historical input through the application in the user terminal 140. The on-line service system 100 may send relevant historical TOIs to the application in the user terminal 140 based on the historical input. The user may select one of the relevant historical TOIs that he/she is interested in through the application in the user terminal 140. The processing engine 112 may store the selected historical TOI associated with the user input in a storage medium (e.g., the storage device 150 and/or the storage 220) of the on-line service system 100.

In some embodiments, the historical information obtaining module 420 may compare the user input with the historical inputs stored in the storage medium. The historical information obtaining module 420 may select the historical inputs that are substantially similar to the user input based on the comparison results and determine the historical TOIs relating to the selected historical inputs as the candidate TOIs. For example, if the user input is “Bank of China” and there are historical TOIs relating to historical inputs including “Bank of China,” “BC,” “Bank of Chi,” and “KFC” in the storage medium, the historical information obtaining module 420 may determine the historical TOIs relating to the historical inputs of “Bank of China,” “BC,” and “Bank of Chi” as the candidate TOIs. In some embodiments, the plurality of candidate TOIs may correspond to a prior time period (e.g., last one week, last one month, last six months, etc). In some embodiments, “substantially similar” means that the relevance between the historical TOI and the user input is higher than a predetermined threshold.

In some embodiments, each of the plurality of candidate TOIs may belong to a candidate category. Merely by way of example, in an on-line service (e.g., a taxi hailing service, a navigation service, a delivery service, a take-out service, etc) in which a user can search a location, the candidate category may include a general request category, a chain request category, and a precise request category. If a candidate TOI belongs to the general request category, it may refer to that there are several entities named by the TOI. For example, a candidate TOI such as “Bank of China” may belong to the general request category because there are several entities (e.g., a subway station—Bank of China Subway Station, a bus station—Bank of China Bus Station, etc.) named by Bank of China. If a candidate TOI belongs to the chain request category, it may refer to that the TOI may be associated with a chain store. For example, candidate TOIs such as “KFC,” “McDonald's,” and “Hilton Hotel” may belong to the chain request category. If a candidate TOI belongs to the precise request category, it may refer to that the TOI may be related to a specific address. For example, candidate TOIs such as “3042 Steinway Street,” and “Bank of China, Xicheng District” may belong to the precise request category.

In some embodiments, the historical information obtaining module 420 may obtain the plurality of candidate TOIs and the candidate categories that each of the candidate TOIs belongs to from the storage device 150, the storage 220, a terminal (e.g., the user terminal 140), and/or an external data source (not shown) via the network 120.

The category determination module 430 may be configured to determine a target category for the user input based on the candidate categories and the plurality of candidate TOIs.

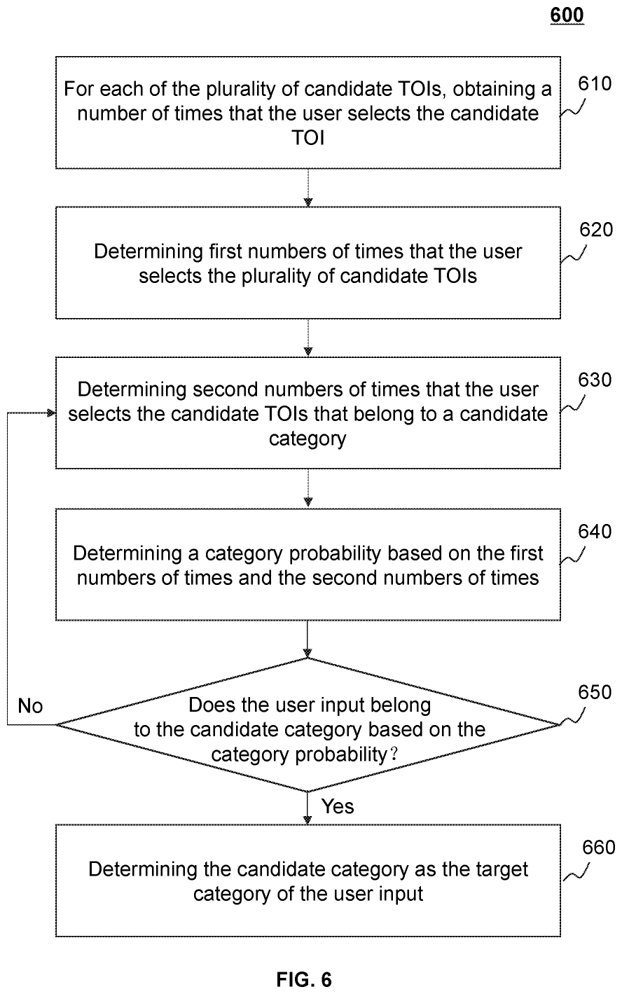

In some embodiments, for at least one of the candidate categories, the category determination module 430 may determine at least one category probability that the user input belongs to the at least one of the candidate categories based on the plurality of candidate TOIs. The category determination module 430 may further determine one of the candidate categories as the target category based on the at least one category probability. More descriptions of the determination of the category probability may be found elsewhere in the present disclosure (e.g., FIG. 6 and the description thereof).

The TOI determination module 440 may be configured to determine one or more target TOIs based on the target category and the plurality of candidate TOIs.

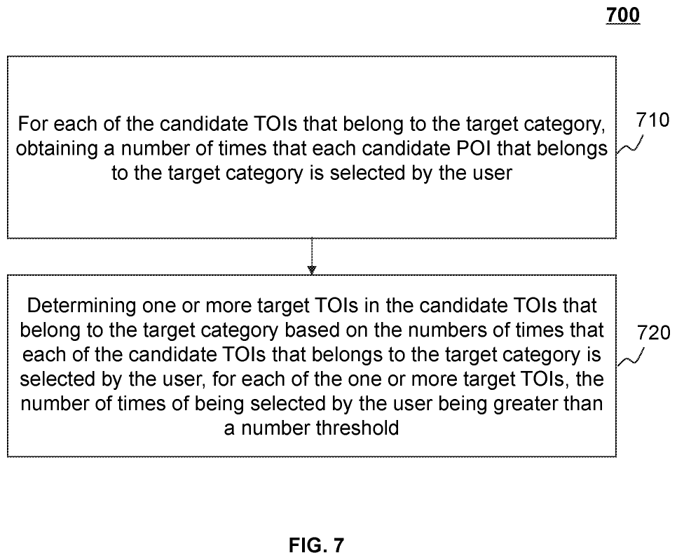

In some embodiments, the TOI determination module 440 may determine the one or more target TOIs based on a number of times that the user selects each of the candidate TOIs. For example, if the number of times that the user selects a candidate TOI belonging to the target category is greater than a number threshold (e.g., 5 times, 10 times, 20 times), the TOI determination module 440 may determine the candidate TOI as a target TOI. As another example, the TOI determination module 440 may rank the number of times that the user selects each of the candidate TOIs. The TOI determination module 440 may determine the one or more target TOIs based on the rank result. Merely by way of example, the TOI determination module 440 may determine the top 3 candidate TOIs that belong to the target category as the target TOIs based on a descending-order rank result. More descriptions of the determination of the one or more target TOIs based on the number of times that the user selects each of the candidate TOIs may be found elsewhere in the present disclosure (e.g., FIGS. 7 and the description thereof).

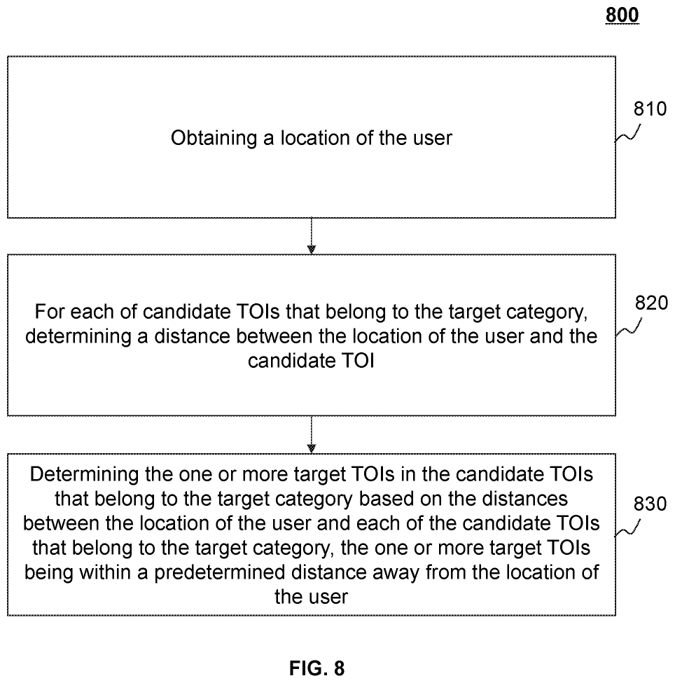

In some embodiments, the TOI determination module 440 may determine the one or more target TOIs based on distances between a location of the user and the candidate TOIs that belong to the target category. For example, if a candidate TOI that belongs to the target category is within a predetermined distance (e.g., 50 m, 100 m, 200 m, 500 m, 1 km, 2 km, 5 km, etc.) away from the location of the user, the TOI determination module 440 may determine the candidate TOI as a target TOI. As another example, the TOI determination module 440 may rank the TOIs based on the distances between the location of the user and the candidate TOIs that belong to the target category. In some embodiments, the TOI determination module 440 may determine the one or more target TOIs based on the rank result. Merely by way of example, the TOI determination module 440 may determine the top 3 candidate TOIs that belong to the target category as the target TOIs based on the descending-order rank result. More descriptions of the determination of the one or more target TOIs based on the distances between the location of the user and the candidate TOIs may be found elsewhere in the present disclosure (e.g., FIG. 8 and the description thereof).

In some embodiments, the TOI determination module 440 may determine the one or more target TOIs based on a relevance between the user input and the candidate TOIs that belong to the target category. For example, the TOI determination module 440 may determine a similarity between the user input and the candidate TOI that belong to the target category by matching each character of the user input and the candidate TOI. A higher similarity between the characters of the user input and the characters of the candidate TOI that belongs to the target category may correspond to a higher relevance between the user input and the candidate TOI that belongs to the target category. In some embodiments, the TOI determination module 440 may rank the candidate TOIs that belong to the target category based on the relevance between the user input and each of the candidate TOIs that belong to the target category. The TOI determination module 440 may further determine one or more of the candidate TOIs that belong to the target category (e.g., top 1, top 5, top 10, top 15, top 20, top 1%, top 5%, top 10%, top 20%) as the one or more target TOIs based on the descending-order ranking result.

In some embodiments, the ways of determining the one or more target TOIs for different candidate categories may be different or similar. For example, if the category determination module 430 determines that the user input belongs to the general request category or the chain request category in 530 (e.g., the target category of the user input is the general request category or the chain request category), the TOI determination module 440 may determine the one or more target TOIs based on the distances between the location of the user and the candidate TOIs that belong to the target category and/or the number of times that the user selects each of the candidate TOIs that belongs to the target category. As another example, if the category determination module 430 determines that the user input belongs to the precise request category in 530 (e.g., the target category of the user input is the precise request category), the TOI determination module 440 may determine the one or more target TOIs based on the number of times that the user selects each of the candidate TOIs that belong to the target category.

In some embodiments, the target category of the user input may indicate a search intention of the user. If the user input belongs to a target category of the general request category, it may indicate that the user intends to input an entity (e.g., a subway station, a bus station, a hospital) of which the name is related to the user input. For example, the user input is “Bank of China,” the target category of the user input is the general request category, and it may indicate that the user intends to input an entity named by “Bank of China”, such as a subway station of Bank of China. If the user input belongs to a target category of the chain request category, it may indicate that the user intends to input a chain store relating to the user input. For example, the user input is “Bank of China,” the target category of the user input is the chain request category, and it may indicate that the user intends to input a branch of Bank of China, such as Chaoyang branch of Bank of China. If the user input belongs to a target category of the precise request category, it may indicate that the user intends to input an accurate address relating to the user input. For example, the user input is “Bank of China,” the target category of the user input is the precise request category, and it may indicate that the user intends to input an accurate address of a location relating to Bank of China, such as Bank of China subway station, Exit A, or Chaoyang branch of Bank of China.

The transmission module 450 may be configured to transmit the one or more target TOIs to a terminal associated with the user (e.g., the user terminal 140). The transmission module 450 may transmit the one or more target TOIs to a user interface of the application in the user terminal 140. More descriptions of the user interface displaying the user input and the target TOIs may be found elsewhere in the present disclosure (e.g., FIGS. 9-12 and the description thereof).

In some embodiments, in the user interface of the application in the user terminal 140, the displayed target TOIs may be arranged as described in connection with 540. For example, the target TOIs may be arranged based on the number of times of being selected by the user. The target TOI with the highest user selection number may be shown on the top of a TOI list (e.g., a TOI list 920 in FIG. 9) in the user interface of the application in the user terminal 140. As another example, the target TOIs may be arranged based on the distances between the location of the user and the target TOIs. The target TOI closest to the location of the user may be shown on the top of the TOI list.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. However, those variations and modifications do not depart the scope of the present disclosure. In some embodiments, the processing engine 112 may include one or more other modules. For example, the processing engine 112 may include a storage module to store data generated by the modules in the processing engine 112. In some embodiments, any two of the modules may be combined as a single module, and any one of the modules may be divided into two or more units.

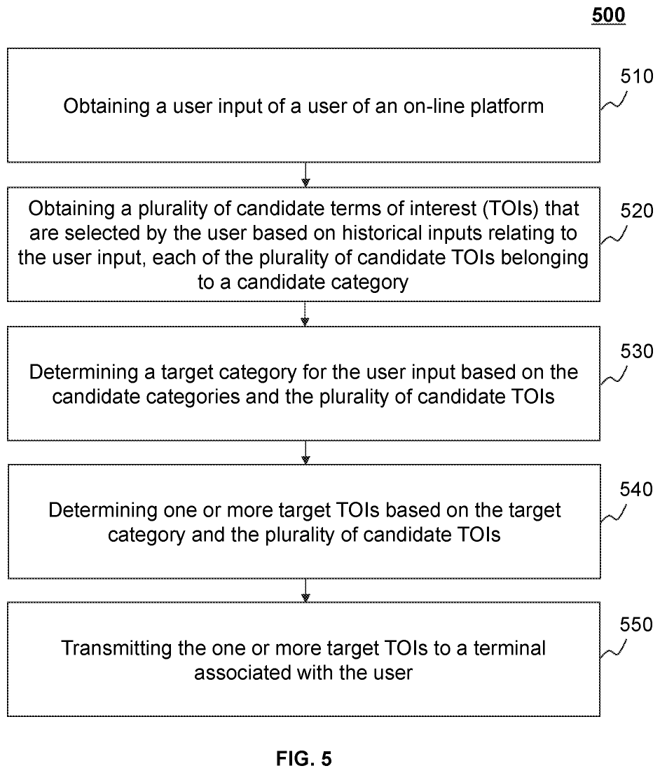

FIG. 5 is a flowchart illustrating an exemplary process for transmitting target TOIs to a terminal associated with a user according to some embodiments of the present disclosure. In some embodiments, the process 500 may be implemented in the on-line service system 100 illustrated in FIG. 1. For example, the process 500 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 510, the input obtaining module 410 (or the processing engine 112, and/or the interface circuits 210-a) may obtain a user input of a user of the on-line service system 100. In some embodiments, the input obtaining module 410 may obtain the user input from the user terminal 140 via the network 120.

In some embodiments, the user terminal 140 may establish a communication (e.g., wireless communication) with the server 110, through an application (e.g., the application 380 in FIG. 3) installed in the user terminal 140 or a webpage in a browser via the network 120. The application may be associated with the on-line service system 100. For example, the application may be a taxi-hailing application associated with the on-line service system 100.

In some embodiments, after the user inputs a user input (e.g., a query), the user may send the user input to the processing engine 112 (e.g., the input obtaining module 410) by, for example, pressing a button in an interface of the application. In some embodiments, the application installed in the user terminal 140 may direct the user terminal 140 to monitor, continuously or periodically, input from the user and automatically transmit the input to the processing engine 112 via the network 120.

In some embodiments, the user input may be in the form of text, audio, video, or graph. The user input may include one or more words (e.g., as shown in a search box 910 in FIGS. 9-11), an incomplete word, an abbreviation (e.g., as shown in the search box 910 in FIG. 12), or the like, or any combination thereof. For example, the user input may be “bank,” “ba,” or “KFC”.

In 520, the historical information obtaining module 420 (or the processing engine 112, and/or the processing circuits 210-b) may obtain a plurality of candidate terms of interest (TOIs) that are selected by the user based on historical inputs relating to the user input.

In some embodiments, the TOI may be a point of interest (POI) (e.g., name of a location or a business name). For example, the POI may relate to a destination of a trip in a taxi hailing service. In some embodiments of the present invention, POIs may serve as examples of TOIs, as shown in the examples herein provided. It should be noted, however, that in some embodiments, the systems and methods of the present invention may apply to TOIs that are not POIs.

In some embodiments, the user may input a historical input through the application in the user terminal 140. The on-line service system 100 may send relevant historical TOIs to the application in the user terminal 140 based on the historical input. The user may select one of the relevant historical TOIs that he/she is interested in through the application in the user terminal 140. The processing engine 112 may store the selected historical TOI associated with the user input in a storage medium (e.g., the storage device 150 and/or the storage 220) of the on-line service system 100.

In some embodiments, the historical information obtaining module 420 may compare the user input with the historical inputs stored in the storage medium. The historical information obtaining module 420 may select the historical inputs that are substantially similar to the user input based on the comparison results and determine the historical TOIs relating to the selected historical inputs as the candidate TOIs. For example, if the user input is “Bank of China” and there are historical TOIs relating to historical inputs including “Bank of China,” “BC,” “Bank of Chi,” and “KFC” in the storage medium, the historical information obtaining module 420 may determine the historical TOIs relating to the historical inputs of “Bank of China,” “BC,” and “Bank of Chi” as the candidate TOIs. In some embodiments, the plurality of candidate TOIs may correspond to a prior time period (e.g., last one week, last one month, last six months, etc). In some embodiments, “substantially similar” means that the relevance between the historical TOI and the user input is higher than a predetermined threshold.

In some embodiments, each of the plurality of candidate TOIs may belong to a candidate category. Merely by way of example, in an on-line service (e.g., a taxi hailing service, a navigation service, a delivery service, a take-out service, etc) in which a user can search a location, the candidate category may include a general request category, a chain request category, and a precise request category. If a candidate TOI belongs to the general request category, it may refer to that there are several entities named by the TOI. For example, a candidate TOI such as “Bank of China” may belong to the general request category because there are several entities (e.g., a subway station—Bank of China Subway Station, a bus station—Bank of China Bus Station, etc.) named by Bank of China. If a candidate TOI belongs to the chain request category, it may refer to that the TOI may be associated with a chain store. For example, candidate TOIs such as “KFC,” “McDonald's,” and “Hilton Hotel” may belong to the chain request category. If a candidate TOI belongs to the precise request category, it may refer to that the TOI may be related to a specific address. For example, candidate TOIs such as “3042 Steinway Street,” and “Bank of China, Xicheng District” may belong to the precise request category.

In some embodiments, the historical information obtaining module 420 may obtain the plurality of candidate TOIs and the candidate categories that each of the candidate TOIs belongs to from the storage device 150, the storage 220, a terminal (e.g., the user terminal 140), and/or an external data source (not shown) via the network 120.

In 530, the category determination module 430 (or the processing engine 112, and/or the processing circuits 210-b) may determine a target category for the user input based on the candidate categories and the plurality of candidate TOIs.

In some embodiments, for at least one of the candidate categories, the category determination module 430 may determine at least one category probability that the user input belongs to the at least one of the candidate categories based on the plurality of candidate TOIs. The category determination module 430 may further determine one of the candidate categories as the target category based on the at least one category probability. More descriptions of the determination of the category probability may be found elsewhere in the present disclosure (e.g., FIG. 6 and the description thereof).

In 540, the TOI determination module 440 (or the processing engine 112, and/or the processing circuits 210-b) may determine one or more target TOIs based on the target category and the plurality of candidate TOIs.

In some embodiments, the TOI determination module 440 may determine the one or more target TOIs based on a number of times that the user selects each of the candidate TOIs. For example, if the number of times that the user selects a candidate TOI belonging to the target category is greater than a number threshold (e.g., 5 times, 10 times, 20 times), the TOI determination module 440 may determine the candidate TOI as a target TOI. As another example, the TOI determination module 440 may rank the number of times that the user selects each of the candidate TOIs. The TOI determination module 440 may determine the one or more target TOIs based on the rank result. Merely by way of example, the TOI determination module 440 may determine the top 3 candidate TOIs that belong to the target category as the target TOIs based on a descending-order rank result. More descriptions of the determination of the one or more target TOIs based on the number of times that the user selects each of the candidate TOIs may be found elsewhere in the present disclosure (e.g., FIGS. 7 and the description thereof).

In some embodiments, the TOI determination module 440 may determine the one or more target TOIs based on distances between a location of the user and the candidate TOIs that belong to the target category. For example, if a candidate TOI that belongs to the target category is within a predetermined distance (e.g., 50 m, 100 m, 200 m, 500 m, 1 km, 2 km, 5 km, etc.) away from the location of the user, the TOI determination module 440 may determine the candidate TOI as a target TOI. As another example, the TOI determination module 440 may rank the TOIs based on the distances between the location of the user and the candidate TOIs that belong to the target category. In some embodiments, the TOI determination module 440 may determine the one or more target TOIs based on the rank result. Merely by way of example, the TOI determination module 440 may determine the top 3 candidate TOIs that belong to the target category as the target TOIs based on the descending-order rank result. More descriptions of the determination of the one or more target TOIs based on the distances between the location of the user and the candidate TOIs may be found elsewhere in the present disclosure (e.g., FIG. 8 and the description thereof).

In some embodiments, the TOI determination module 440 may determine the one or more target TOIs based on a relevance between the user input and the candidate TOIs that belong to the target category. For example, the TOI determination module 440 may determine a similarity between the user input and the candidate TOI that belong to the target category by matching each character of the user input and the candidate TOI. A higher similarity between the characters of the user input and the characters of the candidate TOI that belongs to the target category may correspond to a higher relevance between the user input and the candidate TOI that belongs to the target category. In some embodiments, the TOI determination module 440 may rank the candidate TOIs that belong to the target category based on the relevance between the user input and each of the candidate TOIs that belong to the target category. The TOI determination module 440 may further determine one or more of the candidate TOIs that belong to the target category (e.g., top 1, top 5, top 10, top 15, top 20, top 1%, top 5%, top 10%, top 20%) as the one or more target TOIs based on the descending-order ranking result.

In some embodiments, the ways of determining the one or more target TOIs for different candidate categories may be different or similar. For example, if the category determination module 430 determines that the user input belongs to the general request category or the chain request category in 530 (e.g., the target category of the user input is the general request category or the chain request category), the TOI determination module 440 may determine the one or more target TOIs based on the distances between the location of the user and the candidate TOIs that belong to the target category and/or the number of times that the user selects each of the candidate TOIs that belongs to the target category. As another example, if the category determination module 430 determines that the user input belongs to the precise request category in 530 (e.g., the target category of the user input is the precise request category), the TOI determination module 440 may determine the one or more target TOIs based on the number of times that the user selects each of the candidate TOIs that belong to the target category.

In some embodiments, the target category of the user input may indicate a search intention of the user. If the user input belongs to a target category of the general request category, it may indicate that the user intends to input an entity (e.g., a subway station, a bus station, a hospital) of which the name is related to the user input. For example, the user input is “Bank of China,” the target category of the user input is the general request category, and it may indicate that the user intends to input an entity named by “Bank of China”, such as a subway station of Bank of China. If the user input belongs to a target category of the chain request category, it may indicate that the user intends to input a chain store relating to the user input. For example, the user input is “Bank of China,” the target category of the user input is the chain request category, and it may indicate that the user intends to input a branch of Bank of China, such as Chaoyang branch of Bank of China. If the user input belongs to a target category of the precise request category, it may indicate that the user intends to input an accurate address relating to the user input. For example, the user input is “Bank of China,” the target category of the user input is the precise request category, and it may indicate that the user intends to input an accurate address of a location relating to Bank of China, such as Bank of China subway station, Exit A, or Chaoyang branch of Bank of China.

In 550, the transmission module 450 (or the processing engine 112, and/or the interface circuits 210-a) may transmit the one or more target TOIs to a terminal associated with the user (e.g., the user terminal 140). The transmission module 450 may transmit the one or more target TOIs to a user interface of the application in the user terminal 140. More descriptions of the user interface displaying the user input and the target TOIs may be found elsewhere in the present disclosure (e.g., FIGS. 9-12 and the description thereof).

In some embodiments, in the user interface of the application in the user terminal 140, the displayed target TOIs may be arranged as described in connection with 540. For example, the target TOIs may be arranged based on the number of times of being selected by the user. The target TOI with the highest user selection number may be shown on the top of a TOI list (e.g., a TOI list 920 in FIG. 9) in the user interface of the application in the user terminal 140. As another example, the target TOIs may be arranged based on the distances between the location of the user and the target TOIs. The target TOI closest to the location of the user may be shown on the top of the TOI list.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing step) may be added elsewhere in the exemplary process 500. In the storing step, the processing engine 112 may store information and/or data associated with the candidate TOIs in a storage medium (e.g., the storage 150), which is disclosed elsewhere in the present disclosure.

FIG. 6 is a flowchart illustrating an exemplary process for determining a target category for the user input according to some embodiments of the present disclosure. In some embodiments, the process 600 may be implemented in the on-line service system 100 illustrated in FIG. 1. For example, the process 600 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting. In some embodiments, part of 530 illustrated in FIG. 5 may be performed according to the process 600.

In 610, for each of the plurality of candidate TOIs, the category determination module 430 (or the processing engine 112, and/or the processing circuits 210-b) may obtain a number of times that the user selects the candidate TOI. In some embodiments, the user may select a same TOI multiple times in the prior time period. The category determination module 430 may obtain the number of times that the user selects the candidate TOI by accessing the storage medium (e.g., the storage device 150, the storage 220) to determine the number of the candidate TOIs in the prior time period in the storage medium.

In 620, the category determination module 430 (or the processing engine 112, and/or the processing circuits 210-b) may determine first numbers of times that the user selects the plurality of candidate TOIs.

In some embodiments, the category determination module 430 may determine the first numbers of times that the user selects the plurality of candidate TOIs based on the number of times that the user selects each of the candidate TOIs. For example, the first numbers of times may be a sum of the number of times that the user selects each of the candidate TOIs.

In 630, the category determination module 430 (or the processing engine 112, and/or the processing circuits 210-b) may determine second numbers of times that the user selects the candidate TOIs that belong to a candidate category.

In some embodiments, the category determination module 430 may determine the second numbers of times based on the candidate categories for each of the candidate TOIs and the number of times that the user selects each of the candidate TOIs. For example, the category determination module 430 may select the candidate TOIs that belong to the general request category and determine the second numbers of times by determining a sum of the numbers of times that the user selects the candidate TOIs that belong to the general request category.

In 640, the category determination module 430 (or the processing engine 112, and/or the processing circuits 210-b) may determine a category probability based on the first numbers of times and the second numbers of times. For example, the category determination module 430 may determine the category probability for the candidate category (e.g., the general request category) by dividing the second numbers of times by the first numbers of times.

In some embodiments, the category probability of the candidate category may be determined based on Equation (1):

P(Cⱼ|Q)=Σᵢ P(poiᵢ ∈Cⱼ)*P(poiᵢ|Q) (1)

where Q may refer to the user input; Cⱼ may refer to the candidate category; poiᵢ may refer to one of the plurality of candidate TOIs, i is a positive integer; P(Cⱼ|Q) may refer to the category probability that the user input belongs to the candidate category; P(poiᵢ ∈Cⱼ|Q) may refer to a probability of selecting poi, that belongs to Cⱼ based on Q;P (poiᵢ ∈Cⱼ) may refer to whether poiᵢ belongs to Cⱼ, P(poiᵢ ∈Cⱼ) is equal to 1 or 0; and P(poiᵢ|Q) may refer to a probability of selecting poi, based on Q, which is determined by dividing a number of times that the user selects poiᵢ by a total number of times that the user selects the plurality of candidate TOIs.

In 650, the category determination module 430 (or the processing engine 112, and/or the processing circuits 210-b) may determine whether the user input belongs to the candidate category based on the category probability. For example, the category determination module 430 may determine whether the category probability that the user input belongs to the candidate category is higher than a preset threshold. In response to a determination that the category probability is higher than the preset threshold, the category determination module 430 may determine that the user input belongs to the candidate category. In response to a determination that the category probability is lower than or equal to the preset threshold, the category determination module 430 may determine that the user input does not belong to the candidate category.

In response to a determination that the user input belongs to the candidate category, the process 600 may proceed to 660 to determine the candidate category as the target category of the user input. In response to a determination that the user input does not belong to the candidate category, the category determination module 430 may determine whether the user input belongs to another candidate category by performing 630-650.

In some embodiments, the preset thresholds for different candidate categories may be same or different. For example, the preset threshold for the general request category may be 95%. The preset threshold for the chain request category may be 20%. The preset threshold for the precise request category may be 20%.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, step 620 and step 630 may be performed simultaneously. As another example, step 620 may be performed after step 630.

FIG. 7 is a flowchart illustrating an exemplary process for determining one or more target TOIs according to some embodiments of the present disclosure. In some embodiments, the process 700 may be implemented in the on-line service system 100 illustrated in FIG. 1. For example, the process 700 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting. In some embodiments, 540 illustrated in FIG. 5 may be performed according to the process 700.

In 710, for each of the candidate TOIs that belong to the target category, the TOI determination module 440 (or the processing engine 112, and/or the processing circuits 210-b) may obtain a number of times that each candidate POI that belongs to the target category is selected by the user.

In 720, the TOI determination module 440 (or the processing engine 112, and/or the processing circuits 210-b) may determine one or more target TOIs in the candidate TOIs that belong to the target category based on the numbers of times that each of the candidate TOIs that belongs to the target category is selected by the user.

In some embodiments, for each candidate TOI that belongs to the target category, the TOI determination module 440 may determine whether the number of times that the user selects the candidate TOI is greater than a number threshold. In response to a determination that the number of times that the user selects the candidate TOI is greater than the number threshold, the TOI determination module 440 may determine the candidate TOI as the target TOI.

In some embodiments, the TOI determination module 440 may rank the candidate TOIs that belong to the target category based on the number of times that the user selects each of the candidates TOIs. The TOI determination module 440 may determine the one or more target TOIs based on the rank result. Merely by way of example, the TOI determination module 440 may determine the top 1, top 5, top 10, top 15, top 20, top 1%, top 5%, top 10%, or top 20% of the candidate TOIs that belong to the target category to be the target TOIs based on a descending-order ranking result.

In some embodiments, if the target category of the user input is the precise request category, the TOI determination module 440 may determine the one or more target TOIs based on the numbers of times that the user selects each of the candidate TOIs belonging to the target category.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 8 is a flowchart illustrating an exemplary process for determining one or more target TOIs according to some embodiments of the present disclosure. In some embodiments, the process 500 may be implemented in the on-line service system 100 illustrated in FIG. 1. For example, the process 500 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting. In some embodiments, 540 illustrated in FIG. 5 may be performed according to the process 800.

In some embodiments, if the TOI is a POI (e.g., a location), the TOI determination module 440 may determine the one or more target TOIs based on distances between the location of the user and the candidate TOIs that belong to the target category.

In 810, the TOI determination module 440 (or the processing engine 112, and/or the processing circuits 210-b) may obtain a location of the user. In some embodiments, the user terminal 140 may obtain the location of the user using a positioning technology (e.g., the positioning system 160).

In 820, for each of candidate TOIs that belong to the target category, the TOI determination module 440 (or the processing engine 112, and/or the processing circuits 210-b) may determine a distance between the location of the user and the candidate TOI.

In some embodiments, the distance may be a straight-line distance or a travel distance from the location of the user to the candidate TOI. For example, the TOI determination module 440 may determine a route from the location of the user to the candidate TOI and determine the travel distance from the location of the user to the candidate TOI by determining the length of the route from the location of the user to the candidate TOI. In some embodiments, the distance herein may be replaced by a shortest travel time from the location of the user to the candidate TOI.

In 830, the TOI determination module 440 (or the processing engine 112, and/or the processing circuits 210-b) may determine the one or more target TOIs in the candidate TOIs that belong to the target category based on the distances between the location of the user and each of the candidate TOIs that belong to the target category.

In some embodiments, for each candidate TOI that belong to the target category, the TOI determination module 440 may determine whether the distance between the location of the user and the candidate TOI is less than a predetermined distance (e.g., 100 m, 200 m, 500 m). In response to a determination that the distance is less than the predetermined distance, the TOI determination module 440 may determine the candidate TOI as a target TOI.

In some embodiments, the TOI determination module 440 may rank the candidate TOIs that belong to the target category based on distances between the location of the user and the candidate TOIs that belong to the target category. The TOI determination module 440 may determine the one or more target TOIs based on the rank result. Merely by way of example, the TOI determination module 440 may determine the top 1, top 5, top 10, top 15, top 20, top 1%, top 5%, top 10%, or top 20% of the candidate TOIs that belong to the target category to be the target TOIs based on a descending-order ranking result.

In some embodiments, if the target category is the general request category or the chain request category, or includes both of these categories, the TOI determination module 440 may determine the one or more target TOIs based on the distances between the location of the user and the candidate TOIs that belong to the target category.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, step 509 may be omitted in some embodiments.

FIGS. 9-12 are schematic diagrams illustrating exemplary user interfaces displaying a user input and target TOIs in a user terminal according to some embodiments of the present disclosure.

As illustrated, the user interface may include a search box 910 and a TOI list 920. The search box 910 may display the user input. The TOI list 920 may display the one or more target TOIs relating to the user input. The user may select a TOI he/she is interested in from the TOI list 920.

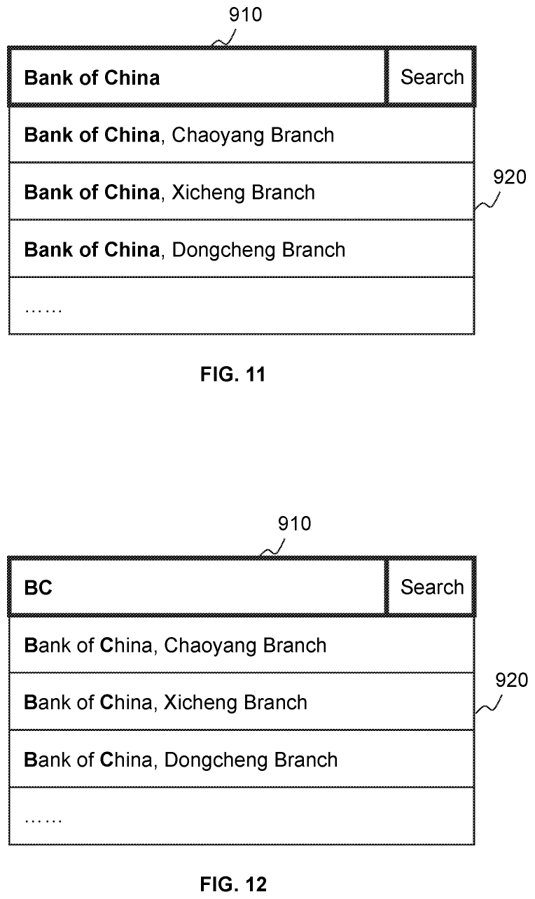

As an example, assuming that the user input is “Bank of China” and the target category for the user input determined by the processing engine 112 is the general request category, the target TOIs may be “Bank of China subway station”, “Bank of China bus station”, or “Bank of China”, as illustrated in FIG. 9. Assuming that the user input is “Bank of China” and the target category for the user input determined by the processing engine 112 is the precise request category, the target TOIs may be “Bank of China subway station, Exit A”, “Bank of China subway station, Exit B”, “Bank of China subway station, Exit C”, or “Bank of China, Chaoyang Branch”, as illustrated in FIG. 10. As another example, assuming that the user input is “Bank of China” and the target category for the user input determined by the processing engine 112 is the chain request category, the target TOIs may be related to the chain bank, for example, “Bank of China, Chaoyang Branch”, “Bank of China, Xicheng Branch”, or “Bank of China, Dongcheng Branch”, as illustrated in FIG. 11.

In some embodiments, the user input may be an incomplete word or an abbreviation. For example, assuming that the user input is “BC” and the target category for the user input determined by the processing engine 112 is the chain request category, the target TOIs may be “Bank of China, Chaoyang Branch”, “Bank of China, Xicheng Branch”, or “Bank of China, Dongcheng Branch”, as illustrated in FIG. 12. As another example, assuming that the user input is “KF” and the target category for the user input determined by the processing engine 112 is the chain request category, the target TOIs may be “KFC, Chaoyang District”, “KFC, Xicheng District”, or “KFC, Dongcheng District”.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for improving user experience for an on-line platform, comprising:
one or more storage media comprising a set of instructions; and
one or more processors configured to communicate with the one or more storage media, wherein when executing the set of instructions, the one or more processors are directed to cause the system to:
obtain a user input of a user of the on-line platform;
obtain a plurality of candidate terms of interest (TOIs) that are selected by the user based on historical inputs relating to the user input, each of the plurality of candidate TOIs belonging to a candidate category;
determine a target category for the user input based on the candidate categories and the plurality of candidate TOIs;
determine one or more target TOIs based on the target category and the plurality of candidate TOIs; and
transmit the one or more target TOIs to a terminal associated with the user.

2. The system of claim 1, wherein the user input includes a word, an incomplete word, or an abbreviation.

3. The system of claim 1, wherein to determine the target category for the user input based on the candidate categories and the plurality of candidate TOIs, the one or more processors are directed to cause the system to:
for at least one of the candidate categories, determine a category probability that the user input belongs to the at least one of the candidate categories based on the plurality of candidate TOIs; and
determine one of the candidate categories as the target category based on the at least one category probability.

4. The system of claim 3, wherein to determine, for at least one of the candidate categories, the category probability that the user input belongs to the at least one of the candidate categories based on the plurality of candidate TOIs, the one or more processors are directed to cause the system to:
for each of the plurality of candidate TOIs, obtain a number of times that the user selects the candidate TOI;
determine a first number of times that the user selects the plurality of candidate TOIs;
determine a second number of times that the user selects the candidate TOIs that belong to the at least one of the candidate categories; and
determine the category probability based on the first number of times and the second number of times.

5. The system of claim 3, wherein to determine, for at least one of the candidate categories, the category probability that the user input belongs to the at least one of the candidate categories based on the plurality of candidate TOIs, the one or more processors are directed to cause the system to:
determine the category probability that the user input belongs to the at least one of the candidate categories based on the following equation:
$$P ( {C}_{j} \vert Q ) = {\sum }_{i} P ( {poi}_{i} ∈ {C}_{j} \vert Q ) = {\sum }_{i} P ( {poi}_{i} ∈ {C}_{j} ) * P ( {poi}_{i} \vert Q )$$
where Q refers to the user input; Cⱼ refers to the at least one of the candidate categories; poiᵢ refers to one of the plurality of candidate TOIs, i is a positive integer; P(Cⱼ|Q) refers to the category probability that the user input belongs to the at least one of the candidate categories; P(poiᵢ ∈Cⱼ|Q) refers to a probability of selecting poiᵢ that belongs to Cⱼ based on Q; P(poiᵢ ∈Cⱼ) refers to whether poiᵢ belongs to Cⱼ, and P(poiᵢ ∈Cⱼ) is equal to 1 or 0; and P(poiᵢ|Q) refers to a probability of selecting poiᵢ based on Q, which is determined by dividing a number of times that the user selects poiᵢ by a total number of times that the user selects the plurality of candidate TOIs.

6. The system of claim 1, wherein the candidate categories include a general request category, a chain request category, and a precise request category.

7. The system of claim 6, wherein to determine the target category for the user input based on the candidate categories and the plurality of candidate TOIs, the one or more processors are directed to cause the system to:
determine a probability of the general request category that the user input belongs to the general request category based on the plurality of candidate TOIs; and
determine the general request category as the target category when the probability of the general request category is higher than a first threshold, or determine the precise request category or the chain request category as the target category when the probability of the general request category is lower than a second threshold.

8. The system of claim 1, wherein to determine the one or more target TOIs based on the target category and the plurality of candidate TOIs, the one or more processors are directed to cause the system to:
obtain a number of times that each candidate POI that belongs to the target category is selected by the user; and
determine the one or more target TOIs in the candidate TOIs that belong to the target category based on the number of times that each candidate POI that belongs to the target category is selected by the user, the number of times that each candidate POI that belongs to the target category is selected by the user being greater than a third threshold.

9. The system of claim 1, wherein to determine the one or more target TOIs based on the target category and the plurality of candidate TOIs, the one or more processors are directed to cause the system to:
obtain a location of the user;
for each of the candidate TOIs that belong to the target category, determine a distance between the location of the user and the candidate TOI; and
determine the one or more target TOIs in the candidate TOIs that belong to the target category based on the distances between the location of the user and each of the candidate TOIs that belong to the target category, the one or more target TOIs being within a predetermined distance away from the location of the user.

10. The system of claim 1, wherein the TOI is a point of interest (POI).

11. A method for improving user experience for an on-line platform implemented on a computing device having one or more processors and one or more storage devices, the method comprising:
obtaining a user input of a user of the on-line platform;
obtaining a plurality of candidate terms of interest (TOIs) that are selected by the user based on historical inputs relating to the user input, each of the plurality of candidate TOIs belonging to a candidate category;
determining a target category for the user input based on the candidate categories and the plurality of candidate TOIs;
determining one or more target TOIs based on the target category and the plurality of candidate TOIs; and
transmitting the one or more target TOIs to a terminal associated with the user.

12. The method of claim 11, wherein the user input includes a word, an incomplete word, or an abbreviation.

13. The method of claim 11, wherein determining the target category for the user input based on the candidate categories and the plurality of candidate TOIs includes:
for at least one of the candidate categories, determining a category probability that the user input belongs to the at least one of the candidate categories based on the plurality of candidate TOIs; and
determining one of the candidate categories as the target category based on the at least one category probability.

14. The method of claim 13, wherein determining, for at least one of the candidate categories, the category probability that the user input belongs to the at least one of the candidate categories based on the plurality of candidate TOIs includes:
for each of the plurality of candidate TOIs, obtaining a number of times that the user selects the candidate TOI;
determining a first number of times that the user selects the plurality of candidate TOIs;
determining a second number of times that the user selects the candidate TOIs that belong to the at least one of the candidate categories; and
determining the category probability based on the first number of times and the second number of times.

15. The method of claim 13, wherein determining, for at least one of the candidate categories, the category probability that the user input belongs to the at least one of the candidate categories based on the plurality of candidate TOIs includes:
determining the category probability that the user input belongs to the at least one of the candidate categories based on the following equation:
$$P ( {C}_{j} \vert Q ) = {\sum }_{i} P ( {poi}_{i} ∈ {C}_{j} \vert Q ) = {\sum }_{i} P ( {poi}_{i} ∈ {C}_{j} ) * P ( {poi}_{i} \vert Q )$$
where Q refers to the user input; Cⱼ refers to the at least one of the candidate categories; poiᵢ refers to one of the plurality of candidate TOIs, i is a positive integer; P(Cⱼ|Q) refers to the category probability that the user input belongs to the at least one of the candidate categories; P(poiᵢ ∈Cⱼ|Q) refers to a probability of selecting poi, that belongs to Cⱼ based on Q; P(poiᵢ ∈Cⱼ) refers to whether poiᵢ belongs to Cⱼ, and P(poiᵢ ∈Cⱼ) is equal to 1 or 0; and P(poiᵢ|Q) refers to a probability of selecting poi, based on Q, which is determined by dividing a number of times that the user selects poiᵢ by a total number of times that the user selects the plurality of candidate TOIs.

16. The method of claim 11, wherein the candidate categories include a general request category, a chain request category, and a precise request category.

17. The method of claim 16, wherein determining the target category for the user input based on the candidate categories and the plurality of candidate TOIs includes:
determining a probability of the general request category that the user input belongs to the general request category based on the plurality of candidate TOIs; and
determining the general request category as the target category when the probability of the general request category is higher than a first threshold, or determine the precise request category or the chain request category as the target category when the probability of the general request category is lower than a second threshold.

18. The method of claim 11, wherein determining the one or more target TOIs based on the target category and the plurality of candidate TOIs includes:
obtaining a number of times that each candidate POI that belongs to the target category is selected by the user; and
determining the one or more target TOIs in the candidate TOIs that belong to the target category based on the number of times that each candidate POI that belongs to the target category is selected by the user, the number of times that each candidate POI that belongs to the target category is selected by the user being greater than a third threshold.

19. The method of claim 11, wherein determining the one or more target TOIs based on the target category and the plurality of candidate TOIs includes:
obtaining a location of the user;
for each of the candidate TOIs that belong to the target category, determining a distance between the location of the user and the candidate TOI; and
determining the one or more target TOIs in the candidate TOIs that belong to the target category based on the distances between the location of the user and each of the candidate TOIs that belong to the target category, the one or more target TOIs being within a predetermined distance away from the location of the user.

20. (canceled)

21. A non-transitory computer readable medium, comprising at least one set of instructions for improving user experience for an on-line platform, wherein when executed by one or more processors of a computing device, the at least one set of instructions causes the computing device to perform a method, the method comprising:
obtaining a user input of a user of the on-line platform;
obtaining a plurality of candidate terms of interest (TOIs) that are selected by the user based on historical inputs relating to the user input, each of the plurality of candidate TOIs belonging to a candidate category;
determining a target category for the user input based on the candidate categories and the plurality of candidate TOIs;
determining one or more target TOIs based on the target category and the plurality of candidate TOIs; and
transmitting the one or more target TOIs to a terminal associated with the user.

22. (canceled)
